(19) United States
(12) Patent Application Publication
(10) Pub. No.: US 2012/0073673 A1
(43) Pub. Date: Mar. 29, 2012

(54) SOLUTION SENDING SYSTEM AND SOLUTION SENDING METHOD

(76) Inventor: Kenji Kameyama, Kanagawa (JP)

(21) Appl. No.: 13/030,773

(22) Filed: Feb. 18, 2011

(30) Foreign Application Priority Data
Sep. 27, 2010 (JP) 2010-215390

(51) Int. Cl. F15D 1/00

(52) U.S. Cl. 137/14; 137/565.01

(57) ABSTRACT

A solution sending system includes a flow path; a pump including a space that also serves as part of the flow path; a flow volume detection unit that detects a flow volume per unit time in the flow path; a control unit that controls the pump in accordance with a detected value of the flow volume detection unit and a set value; and a flow path resistance changing unit that changes a flow path resistance in the flow path. The flow path resistance changing unit changes the flow path resistance in the flow path in accordance with the detected value and the set value.

### BACKGROUND OF THE INVENTION

1. Field of the Invention

The present invention relates to a solution sending system using a micro-pump and a method of controlling the solution sending system.

2. Description of the Related Art

Conventionally, pumps used in drip infusion apparatuses are relatively large. Thus, even when a portable drip infusion apparatus is used, it is difficult for the patient to freely walk around.

One approach is to use a compact-sized micro-pump. The micro-pump sends a solution by changing the volume of a space formed in a substrate by oscillation of an actuator. The substrate is made of a material that is easy to process such as silicon. By using such a micro-pump, the patient can move around more easily while being administered intravenous drips, compared to the case of using conventional large-sized pumps.

A diffuser type micro-pump that uses a piezoelectric element has the following configuration. The diffuser type micro-pump includes a pressure chamber that is made by forming a space in a substrate made of a material that is easy to process such as silicon. The inside of the chamber through which the infusion solution passes receives pressure as the piezoelectric element bends. The cross-sectional area of the diffuser structure gradually increases, so that the flow volume in the forward direction (the flow volume from the inlet to the outlet) becomes larger than the flow volume in the backward direction (the flow volume from the outlet to the inlet). Accordingly, the solution is discharged from the outlet by the micro-pump.

Furthermore, there is a valve type pump having the following configuration. The valve type pump includes a pressure chamber that is made by forming a space in a substrate made of a material that is easy to process such as silicon. A valve is provided, which opens only in a direction in which the solution is sent to the pressure chamber. Accordingly, the volume of the pressure chamber can be changed, so that the solution can be sent by the valve type pump.

These types of pumps have the following problem. When an infusion solution bag or an infusion solution bottle filled with an infusion solution (medicinal solution) is located at a higher position than that of the pump when these elements are set on a drip infusion stand, the weight of the infusion solution (gravity) affects the operation of controlling the flow volume of the infusion solution.

There are methods of preventing the infusion solution from flowing due to the weight of the infusion solution (due to gravity). One method is to block the flow path by blocking the tube with a clip, while connecting the medicinal solution bottle to the tube which is the flow path. Another method is to activate a blocking device including an electromagnetic valve, in response to detecting that a tube used for passing the medicinal solution to the infusion solution pump is connected to the infusion solution pump.

Furthermore, patent document 1 discloses the following technology. When the panel of the pump unit opens due to the nurse's error, the flow path is blocked by squeezing the tube from outside with a cam mechanism operated by a servo motor provided outside the tube. When the panel of the pump unit closes, the cam mechanism releases the tube.

According to the technology disclosed in patent document 1, it is possible to prevent the infusion solution from flowing by the weight of the infusion solution (by gravity) due to an error in the operation. However, with the technology disclosed in patent document 1, the flow cannot be completely prevented.

Thus, even with the technology disclosed in patent document 1, it is not possible to solve the following problem of a diffuser type micro-pump or a valve type micro-pump. That is, when the patient moves around, the height from the injection position to the infusion solution bottle changes. Consequently, the weight of the infusion solution may affect the operation of controlling the flow volume of the infusion solution while the solution is being sent to the patient.

Patent Document 1: Japanese Laid-Open Patent Publication No. 2007-222485

### SUMMARY OF THE INVENTION

The present invention provides a solution sending system and a solution sending method, in which one or more of the above-described disadvantages are eliminated.

A preferred embodiment of the present invention provides a solution sending system that uses a micro-pump such as a diffuser type micro-pump and a valve type micro-pump including a space having a pump function serving as a part of a flow path, in which the operation of driving the pump is controlled based on the detection value of the flow volume of the infusion solution flowing through the flow path and a set value that is set in advance as a solution sending flow volume per unit time, and the resistance in the flow path through which the infusion solution is flowing is changed so that the impact of the weight of the infusion solution (gravity) is mitigated.

According to an aspect of the present invention, there is provided a solution sending system including a flow path; a pump including a space that also serves as part of the flow path; flow volume detection unit that detects a flow volume per unit time in the flow path; a control unit that controls the pump in accordance with a detected value of the flow volume detection unit and a set value; and a flow path resistance changing unit that changes a flow path resistance in the flow path, wherein the flow path resistance changing unit changes the flow path resistance in the flow path in accordance with the detected value and the set value.

According to an aspect of the present invention, there is provided a solution sending method performed by a solution sending system including a flow path, a pump including a space that also serves as part of the flow path, a flow volume detection unit that detects a flow volume per unit time in the flow path, a control unit that controls the pump in accordance with a detected value of the flow volume detection unit and a set value, and a flow path resistance changing unit that changes a flow path resistance in the flow path, the solution sending method including a step performed by the flow path resistance changing unit, of changing the flow path resistance in the flow path in accordance with the detected value and the set value.

According to one embodiment of the present invention, a solution sending system and a solution sending method are provided, which are capable of preventing the infusion solution from flowing due to gravity, and controlling the flow volume of the infusion solution with high precision.

### BRIEF DESCRIPTION OF THE DRAWINGS

Other objects, features and advantages of the present invention will become more apparent from the following detailed description when read in conjunction with the accompanying drawings, in which:

FIG. 1 illustrates an overview of an infusion pump apparatus including a solution sending system according to an embodiment of the present invention;

FIGS. 2A and 2B are schematic diagrams for describing an operation concept of a micro-pump used in an embodiment of the present invention;

FIGS. 3A and 3B are schematic diagrams of an operating state of the micro-pump;

FIGS. 4A and 4B illustrate a control unit of the infusion pump system;

FIG. 5 is a flowchart of a first control operation of the infusion pump system;

FIG. 6 is a flowchart of a second control operation of the infusion pump system;

FIG. 7 is a flow chart of a process of performing interruption control when an abnormality occurs;

FIG. 8 is a flow chart of an operation performed by a constricting unit when a system controller is not operating; and

FIG. 9 illustrates a specific example of a flow path resistance changing means for constricting a tube.

### DETAILED DESCRIPTION OF THE PREFERRED EMBODIMENTS

A description is given, with reference to the accompanying drawings, of embodiments of the present invention.

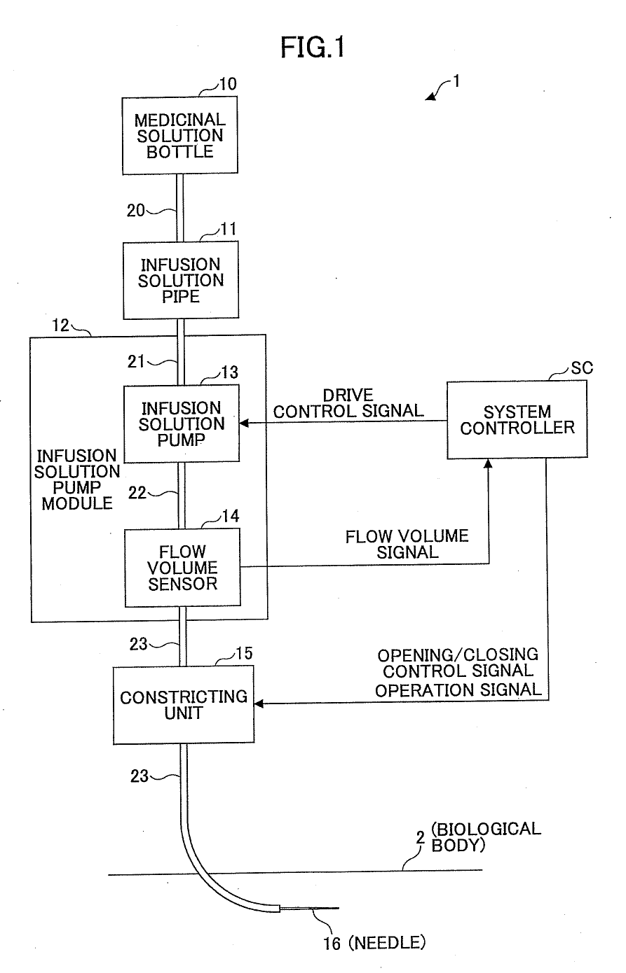

FIG. 1 illustrates an overview of an infusion pump apparatus including a solution sending system according to an embodiment of the present invention.

An infusion pump system 1 includes a medicinal solution bottle (infusion solution container) 10 filled with a medicinal solution or an infusion solution; an infusion solution pipe 11 including one opening connected to the medicinal solution bottle 10 via a tube 20; and a needle 16 that is inserted into a part of a biological body (patient) 2 such as a venous blood vessel for injecting a medicinal solution. Furthermore, the infusion pump system 1 includes an infusion solution pump module 12 including an infusion solution pump 13 and a flow volume sensor (flow volume detecting unit) 14. The infusion solution pump module 12 is connected to the other opening of the infusion solution pipe 11 via a tube 21, and is connected to the needle 16 via a tube 23. Furthermore, the infusion pump system 1 includes a constricting unit 15 provided on the tube 23 connecting the infusion solution pump module 12 and the needle 16. The constricting unit 15 is an example of a means for changing the resistance of a flow path (flow path resistance changing means). The constricting unit 15 constricts/compresses the tube 23 from outside to reduce the inner diameter of the tube 23 so that solution does not flow through the flow path. The constricting unit 15 limits the flow of the medicinal solution by gradually (in a step-by-step manner) increasing the flow path resistance, while allowing a certain amount of fluid to flow through the flow path. The constricting unit 15 facilitates the flow of the medicinal solution inside the tube 23 by gradually (in a step-by-step manner) loosening the constricted state so that the flow path resistance is reduced. Furthermore, the infusion pump system 1 includes a system controller (control unit) SC that is connected to the infusion solution pump 13, the flow volume sensor 14, and the constricting unit 15, for controlling these respective modules.

In the example of FIG. 1, the infusion solution pump 13 and the flow volume sensor 14 form a single module, i.e., the infusion solution pump module 12; however, the present invention is not so limited. The infusion solution pump 13 and the flow volume sensor 14 may be separate components instead of forming a single module. Furthermore, the tubes in the infusion pump system 1 are typical catheters used for drip infusion in hospitals, which have elastic, soft properties.

The flow volume sensor 14 is connected to the infusion solution pump 13 via a tube 22. The flow volume sensor 14 measures the flow volume per unit time of the medicinal solution discharged from the infusion solution pump 13, and supplies the measured flow volume as electric signals to the system controller SC.

In the present embodiment, the medicinal solution flows through a flow path extending from the medicinal solution bottle 10 to the needle 16 by passing through the tube 20, the infusion solution pipe 11, the tube 21, the infusion solution pump 13, the tube 22, the flow volume sensor 14, and the tube 23, in the stated order. A constricting part of the constricting unit 15 is provided on the tube 23.

The infusion solution container is not limited to the medicinal solution bottle 10; the infusion solution container may be, for example, a bag type container such as a vinyl bag.

As described in detail below, the infusion solution pump 13 is a diffuser type micro-pump that uses a piezoelectric element. The infusion solution pump 13 receives, from the system controller SC, drive control signals for controlling the driving frequency and the driving voltage (i.e., the driving amplitude) of the piezoelectric element, so that the flow volume of the discharged medicinal solution is controlled.

The flow path resistance changing means may be any kind of means. Examples are a method of directly compressing the tube 23 from the outside of the tube 23 with a movable arm driven by a motor, or a method of compressing the tube 23 with a screw.

Examples of methods of changing the flow path resistance in the tube 23 are pressing, twisting, and bending the tube 23 from outside with a gear or a roller.

The flow path resistance changing means may be integrally provided in the infusion solution pump module 12. The gear and the roller may be driven with the use of a stepping motor or a regular motor.

A detailed example of the flow path resistance changing means for constricting the tube 23 is described below.

The constricting unit 15 performs control operations as described in detail below, by completely blocking the flow path, or by gradually (in a step-by-step manner) increasing or decreasing the extent of constricting the tube 23 while allowing a certain amount of fluid to flow through the flow path. Accordingly, the resistance in the flow path of the infusion solution is gradually (in a step-by-step manner) increased and decreased.

The constricting unit 15 can be removed from the tube 23, or the constricting unit 15 can be integrally provided in the infusion solution pump module 12. Therefore, the constricting unit 15 may be always provided for a patient who requires such a means (a patient that is expected to move around during the drip infusion). Meanwhile, the constricting unit 15 may not be provided for a patient who does not require such a means (a patient that is not expected to move around during the drip infusion). Accordingly, operating costs can be reduced.

Furthermore, the constricting unit 15 constricts the tube 23 by sandwiching the tube 23 from outside, and therefore the infusion solution does not contact the constricting unit 15. Accordingly, the constricting unit 15 can be repeatedly reused.

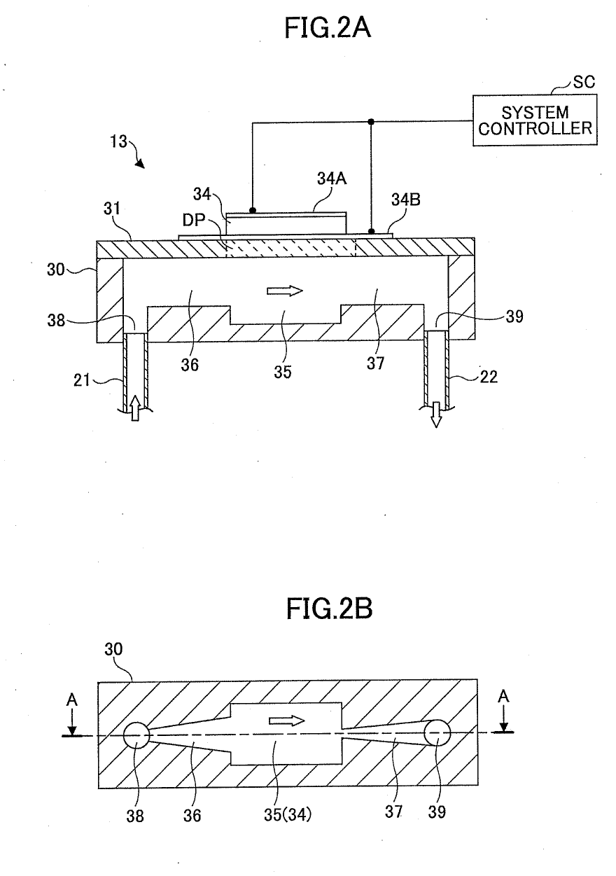

FIGS. 2A and 2B are schematic diagrams for describing the operation concept of the infusion solution pump 13 used in an embodiment of the present invention. FIG. 2A is a cross-sectional view of the infusion solution pump 13 and FIG. 2B is a plan view of the infusion solution pump 13. FIG. 2A is a cross-sectional view of the infusion solution pump 13 cut along a line A-A in FIG. 2B.

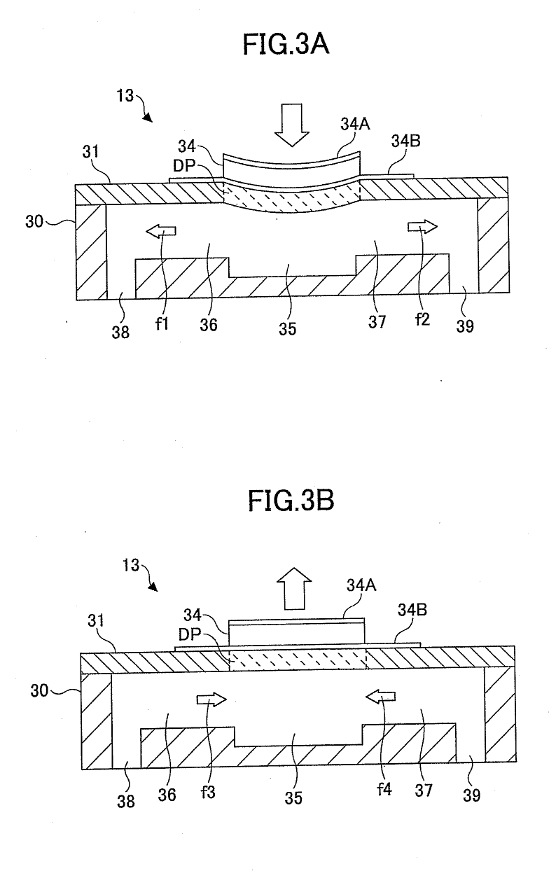

Furthermore, FIGS. 3A and 3B are schematic diagrams of an operating state of the infusion solution pump 13.

The infusion solution pump 13 primarily includes a Si (silicon) substrate 30 in which a groove is formed by etching, and a glass substrate (plate member) 31 that is anodically-bonded to the silicon substrate 30.

A space formed by the groove provided in the silicon substrate 30 and the glass substrate 31 acts as a pressure chamber (pump chamber) 35. A piezoelectric element 34 is provided on the top surface of the glass substrate 31, at a position corresponding to the pressure chamber 35. Diffusers 36 and 37 are formed by etching in the silicon substrate 30 along a direction in which the fluid progresses in the pressure chamber 35. The diffusers 36 and 37 are flow paths having a cross-sectional area that gradually increases.

The piezoelectric element 34 includes electrodes 34A and 34B on opposite sides of the piezoelectric element 34 (the electrodes 34A and 34B are provided on the sides of the piezoelectric element 34 that are configured to bend). Furthermore, the piezoelectric element 34 is provided on the glass substrate 31 via the electrode 34B.

Furthermore, an inlet 38 and an outlet 39 are through holes that are respectively connected to the diffuser 36 and the diffuser 37, in such a manner that fluid can flow through. The inlet 38 and the outlet 39, which respectively act as the inlet and the outlet of the pressure chamber 35, are formed by etching in the silicon substrate 30. The tube 21 is connected to the inlet 38 in such a manner that fluid can flow in from the infusion solution pipe 11. The tube 22 is connected to the outlet 39 in such a manner that fluid can flow out to the flow volume sensor 14. The pressure chamber 35 is connected to the tube 21 and the tube 22 in such a manner that fluid can flow through, so that the pressure chamber 35 acts as a part of the flow path of the constricting unit 15.

As a driving voltage (voltage pulse) is applied to the piezoelectric element 34 from the system controller SC, the piezoelectric element 34 bends. Accordingly, the part of the glass substrate 31 that contacts the piezoelectric element 34 operates as a diaphragm part DP, so that pressure is applied to the pressure chamber 35. Thus, the pressure chamber 35 contracts (see FIG. 3A) and expands (see FIG. 3B). As the pressure chamber 35 contracts and expands, the pressure levels in the diffuser 36 and the diffuser 37 become different. Consequently, the fluid is caused to flow.

To apply the driving voltage to the piezoelectric element 34, the system controller SC applies a voltage between the electrodes 34A and 34B. A positive voltage is applied to the electrode 34A, and the electrode 34B is connected to GND. The difference in potential between the electrodes 34A and 34B acts as the driving voltage for driving the piezoelectric element 34.

As the pressure chamber 35 repeats contracting and expanding, a steady flow of fluid flowing from the inlet 38 to the outlet 39 is generated.

More specifically, as shown in FIG. 2B, the cross-sectional area of the diffuser 36 gradually increases from the inlet 38 to the pressure chamber 35. Furthermore, the cross-sectional area of the diffuser 37 gradually increases from the pressure chamber 35 to the outlet 39. That is to say, the cross-sectional areas of the diffuser 36 and the diffuser 37 gradually increase in a direction indicated by an arrow in FIG. 2B.

By applying a voltage pulse to the piezoelectric element 34, the diaphragm part DP can be oscillated. That is to say, by applying a voltage pulse to the piezoelectric element 34, the pressure chamber 35 repeatedly contracts and expands (expanding meaning expanding from the contracted state). The contraction ratio of the pressure chamber 35 (the extent to which the diaphragm part DP bends) is determined by the pulse amplitude and pulse width of the voltage applied to the piezoelectric element 34. The number of times the pressure chamber 35 repeatedly contracts/expands is determined by the frequency of the voltage pulse.

When the pressure chamber 35 expands (actually, the expansion ratio is 1), the medicinal solution flows into the pressure chamber 35 from both the inlet 38 and the outlet 39.

The fluid that flows into the pressure chamber 35 from the inlet 38 and the outlet 39 passes through the diffuser 36 and the diffuser 37, respectively. As described above, the cross-sectional area of the diffuser 36 and the diffuser 37 gradually increases in the direction indicated by the arrow in FIG. 2B. Therefore, in the diffuser 36 and the diffuser 37, a small resistance is applied to the fluid flowing in the direction indicated by the arrow in FIG. 2B, while a large resistance is applied to the fluid flowing in a direction opposite to the direction indicated by the arrow in FIG. 2B.

Accordingly, in the state illustrated in FIG. 3A, a medicinal solution f1 that is discharged toward the inlet 38 flows in a direction in which the cross-sectional area of the diffuser 36 decreases. Therefore, the resistance is high and the flow volume is low. Meanwhile, a medicinal solution f2 that is discharged toward the outlet 39 flows in a direction in which the cross-sectional area of the diffuser 37 increases. Therefore, the resistance is low and the flow volume is large.

Furthermore, in the state illustrated in FIG. 3B, a medicinal solution f3 that flows in from the inlet 38 flows in a direction in which the cross-sectional area of the diffuser 36 increases. Therefore, the resistance is low and the flow volume is large. Meanwhile, a medicinal solution f4 that flows in from the outlet 39 flows in a direction in which the cross-sectional area of the diffuser 37 decreases. Therefore, the resistance is high and the flow volume is small.

When the pressure chamber 35 contracts and expands once, the net amount of fluid flowing from the inlet 38 to the pressure chamber 35 is |f3−f1|, while the net amount of fluid flowing from the pressure chamber 35 to the outlet 39 is |f2−f4|. Therefore, the net amount of fluid flowing from the inlet 38 to the outlet 39 is f=|f1−f3|=|f4−f2|.

Assuming that the pressure chamber 35 has a volume W and a contraction ratio β, the equation f=W(1−β) is satisfied. As the pressure chamber 35 repeats contracting and expanding, a steady flow of fluid flowing from the inlet 38 to the outlet 39 is generated. Assuming that the number of times (frequency) that the pressure chamber 35 repeats contracting and expanding is ω, a fluid having a volumetric flow volume of F=ωf=ωW(1−β) per unit time flows from the inlet 38 to the outlet 39.

The volumetric flow volume F can be controlled by adjusting at least one of a pulse amplitude V, a pulse width H (pulse area VH), and a pulse period T (frequency 1/T) of the voltage pulse applied to the piezoelectric element 34.

By increasing (or decreasing) the pulse width V (or pulse area VH) of the voltage pulse applied to the piezoelectric element 34, the extent to which the piezoelectric element 34 contracts and expands, i.e., the extent to which the diaphragm part DP bends, increases (or decreases). Therefore, by changing the pulse width V (or pulse area VH), the expansion/contraction ratio (1−β) of the pressure chamber 35 can be adjusted. Accordingly, the flow volume F=ωw(1−β) can be controlled. Furthermore, by increasing (or decreasing) the frequency of the voltage pulse, the frequency of oscillation of the diaphragm part DP (i.e., the frequency o that the pressure chamber 35 repeats contracting/expanding per unit time) increases (or decreases). Accordingly, by changing the frequency of the voltage pulse, the frequency ω that the pressure chamber 35 repeats contracting/expanding per unit time can be adjusted.

However, the structure of the micro-pump is not so limited. For example, it is possible to use a pump capable of sending fluid by the following structure. Specifically, even if the diffusers 36 and 37 are not provided, it is possible to provide a valve in one or both of the inlet 38 and the outlet 39. The valve opens only in the desired direction of the fluid flow. Furthermore, the volume of the pressure chamber 35 is variable.

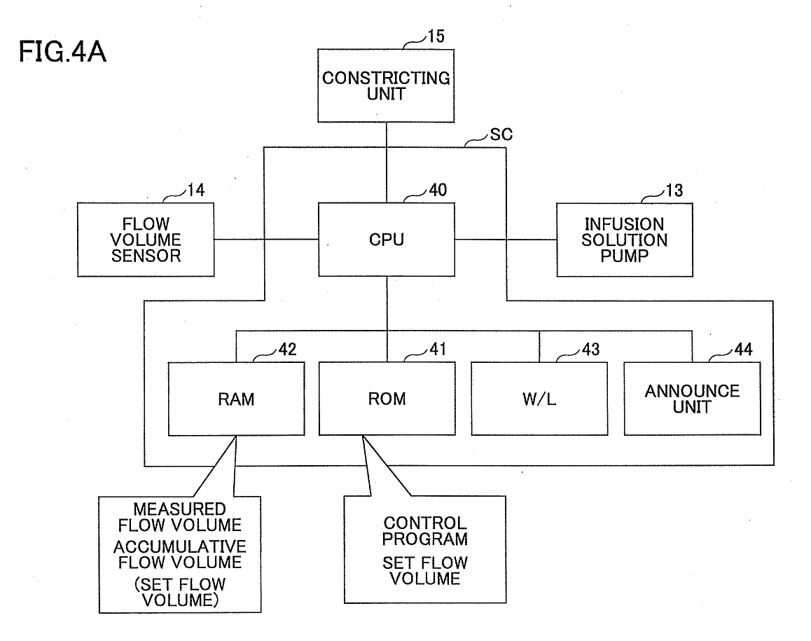

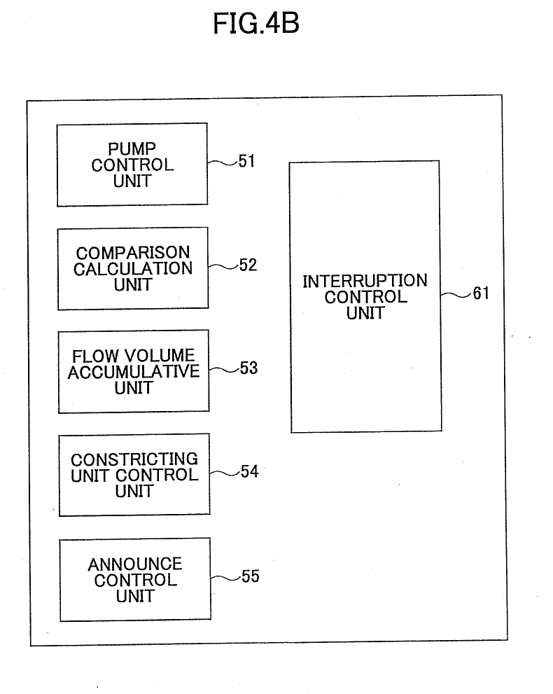

FIGS. 4A and 4B illustrate the control unit of the infusion pump system 1. FIG. 4A is a hardware block diagram and FIG. 4B illustrates a control program executed by the control unit.

As shown in FIG. 4A, the system controller SC includes a CPU 40; a ROM (Read Only Memory) 41 for storing a control program and data relevant to a predetermined ideal flow volume of the medicinal solution per unit time (hereinafter, set flow volume); and a RAM (Random Access Memory) 42 for loading the control program read from the ROM 41 and for being used as a work area for temporarily storing flow volume data that is a detected value acquired from the flow volume sensor 14 (hereinafter, measured flow volume) and calculated data.

Furthermore, the system controller SC includes a wireless (W/L) communications unit 43 for transmitting a signal to a nurse when there is an abnormality in the infusion pump system 1; and an announce unit 44 that announces such an abnormality by emitting light from an LED.

Instead of storing the set flow volume in the ROM 41, the set flow volume may be stored in the RAM 42 by using an input unit to appropriately input a value in accordance with the medicine and the state of the patient.

As described above, the system controller SC is electrically connected to the flow volume sensor 14, the constricting unit 15, and the infusion solution pump 13.

The CPU 40 receives measured flow volume data from the flow volume sensor 14 and compares the measured flow volume with the set flow volume. When the measured flow volume is higher than the set flow volume, the CPU 40 changes the pulse amplitude, the pulse width, and the pulse period of the voltage pulse applied to the piezoelectric element 34 of the infusion solution pump 13 described with reference to FIGS. 2A through 3B, to reduce the fluid sending capability of the infusion solution pump 13. Furthermore, when the CPU 40 compares the measured flow volume with the set flow volume and the measured flow volume is lower than the set flow volume, the CPU 40 increases the fluid sending capability of the infusion solution pump 13.

Furthermore, as shown in FIG. 4B, the CPU 40 executes a pump control unit 51 that controls the infusion solution pump 13 to change the flow volume of the discharged fluid or to stop the operation of the infusion solution pump 13; a comparison calculation unit 52 that compares the set flow volume with the measured flow volume of the fluid; a flow volume accumulative unit 53 that accumulates the measured flow volume and calculates the total amount of medicinal solution that has been infused; a constricting unit control unit 54 that controls the constricting unit 15 to open or block the tube 23; an announce control unit 55 that makes an announcement to a nurse or an external device by controlling the announce unit 44 and the wireless communications unit 43, when the constricting unit 15 has constricted the tube 23 or when the constricting unit 15 cannot normally (properly) constrict the tube 23 in a diagnosis operation described below; and an interruption control unit 61 interrupts processes performed by the respective units and stops the operation of the infusion solution pump 13 and operates the constricting unit 15 when an abnormality occurs in any part of the infusion pump system 1.

Next, a description is given of an operation of controlling the flow volume in the infusion pump system 1 according to an embodiment of the present invention.

The system controller SC includes an input unit (not shown), which can be used by the operator to set the set flow volume that is a set value of the solution sending flow volume per unit time. Other than the set flow volume, the system controller SC holds various set values used for controlling the flow volume, such as the total amount of infusion solution and the operation stop flow volume.

After being started up, the system controller SC reads the total amount of infusion solution and the set value of the solution sending flow volume per unit time that has been set in advance. Next, the system controller SC starts driving the infusion solution pump 13 in accordance with an instruction to start drip infusion that is input with the use of an operation unit (not shown) provided in the system controller SC.

The basic operations are as follows. The system controller SC reads, as the measured flow volume, signals output from the flow volume sensor 14. The comparison calculation unit 52 compares the measured flow volume with the set flow volume. The pump control unit 51 adjusts at least one of the pulse amplitude, the pulse width, and the pulse period of the voltage pulse applied to the piezoelectric element 34, in order to control the operations of the infusion solution pump 13 so that the measured flow volume and the set flow volume become the same.

At the same time, the constricting unit control unit 54 accumulates the flow volume per unit time to calculate the amount of infusion solution injected in the biological body.

The pump control unit 51 compares a predetermined total amount of infusion solution to be injected with the accumulative flow volume value. When the accumulative flow volume value has not reached the predetermined total amount, the pump control unit 51 continues operating the infusion solution pump 13. However, when the accumulative flow volume value has reached the predetermined total amount, the pump control unit 51 stops the operation of the infusion solution pump 13, and ends the drip infusion operation.

However, when the system controller SC cannot receive any signals from the flow volume sensor 14, or when the measured flow volume is greater than or equal to the operation stop flow volume, the interruption control unit 61 interrupts the operation of the infusion solution pump 13. Specifically, regardless of the program being executed, the constricting unit 15 blocks the flow path by constricting the tube 23 and the interruption control unit 61 forcibly stops the pumping operation.

Even if the measured flow volume is not greater than the operation stop flow volume, if the solution sending flow volume becomes greater than or equal to a set value, a regular closed-loop control operation is performed on the infusion solution pump 13, so that the infusion solution pump 13 is driven under conditions for decreasing the flow volume. When the detection value acquired by the flow volume sensor 14 decreases, and once again reaches the set flow volume (or becomes included within a predetermined margin of error with respect to the set flow volume), the regular closed-loop control operation is completed.

Meanwhile, when the solution sending flow volume cannot be controlled to reach the set value even if the driving conditions of the infusion solution pump 13 are changed within a possible range, the following process is performed. That is, in order to remove any impact on the flow volume that flows according to inertia by driving the infusion solution pump 13, the pump control unit 51 stops the infusion solution pump 13 and waits for a predetermined length of time. Then, the pump control unit 51 detects the measured flow volume output by the flow volume sensor 14, as the flow volume of the infusion solution caused by gravity applied on the infusion solution.

When the measured flow volume is greater than the set flow volume, the constricting unit control unit 54 controls the constricting unit 15 to constrict the tube 23 so that the flow volume of infusion solution according to gravity is reduced, and the flow path is constricted by at least an extent such that the measured flow volume can be controlled to reach the set volume when the infusion solution pump 13 is driven and the flow path resistance of the tube 23 is increased.

Accordingly, it is possible to minimize the impact of gravity on the flow volume of the infusion solution, so that the flow volume can be reduced to a level that can be controlled by the infusion solution pump 13.

After the flow volume of the infusion solution according to gravity is reduced by operating the constricting unit 15, operation of the infusion solution pump 13 is resumed, and the operations of constricting the tube 23 and controlling the infusion solution pump 13 are simultaneously performed. Accordingly, the flow volume can be controlled to be a normal flow volume within a short period of time.

When the measured flow volume is lower than the set flow volume, the constricting unit control unit 54 controls the constricting unit 15 to loosen the constriction of the tube 23 so that the flow path resistance in the tube 23 is reduced.

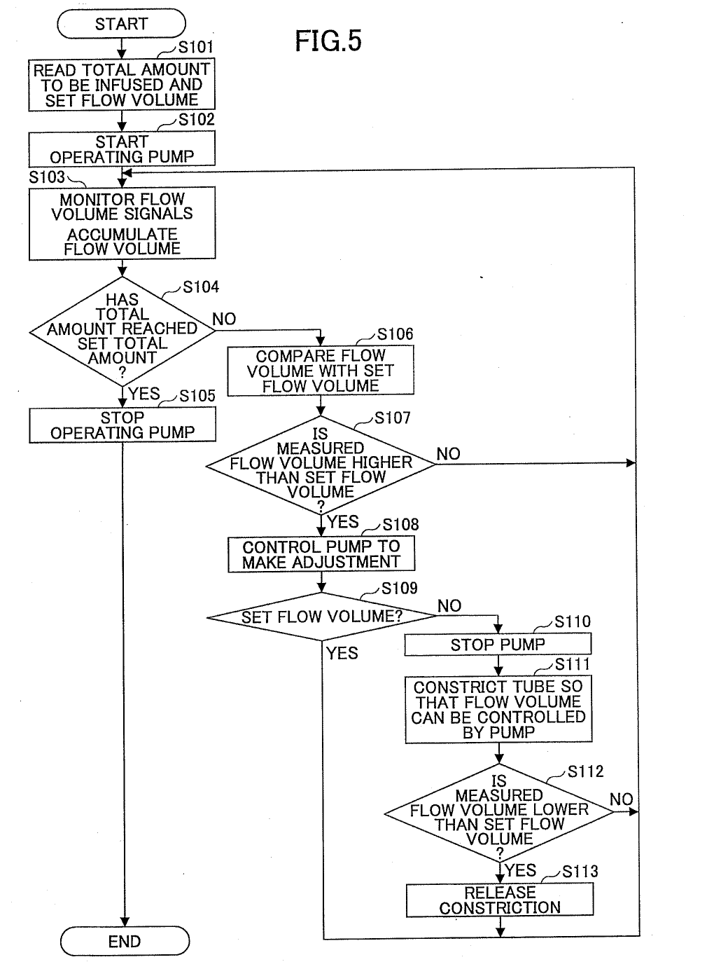

FIG. 5 is a flowchart of a first control operation of the infusion pump system 1 according to an embodiment of the present invention.

For every predetermined time period, the system controller SC compares the sensor flow volume (measured flow volume) with a predetermined threshold (for example, an operation stop flow volume), and detects an abnormality when the sensor flow volume exceeds the threshold.

When the state of the flow volume sensor 14 is normal, and the flow volume is zero, the flow volume sensor 14 outputs signals of 2.5 V to the system controller SC. However, when the output signal is lower than 2.5 V, or when the output signal is 0 V, it is determined that a problem has occurred in the flow volume sensor 14.

The following is a description of a process flow when there are no problems in the output signals or the measured flow volume of the flow volume sensor 14.

When the infusion pump system 1 starts operating, the CPU 40 reads a predetermined total amount of infusion solution (to be infused) and the ideal flow volume per unit time from the ROM 41 (step S101).

Next, the CPU 40 issues a command to operate the infusion solution pump 13 (step S102).

The CPU 40 constantly monitors the flow volume obtained based on signals input from the flow volume sensor 14. Furthermore, the CPU 40 monitors the value of the flow volume sensor 14, and accumulates the total amount of medicinal solution that has flown through the infusion solution pump 13 based on the value of the flow volume sensor 14 (step S103). When the CPU 40 determines that the total amount has reached the predetermined total amount read in step S101 (YES in step S104), it means that the drip infusion has been completed, and therefore the CPU 40 stops the operation of the infusion solution pump 13 (step S105).

When the CPU 40 determines that the total amount has not reached the total amount read in step S101 (NO in step S104), for every predetermined time period, the CPU 40 compares the flow volume obtained based on the value of the flow volume sensor 14 with the set flow volume acquired in step S101 (step S106).

When the measured flow volume is higher than the set flow volume (YES in step S107), the CPU 40 controls the infusion solution pump 13 to increase/decrease/adjust the flow volume by changing the frequency and the driving voltage of the infusion solution pump 13 (step S108).

When the measured flow volume becomes within a threshold range with respect to the set flow volume by performing the control operation (YES in step S109), it is determined that the variation is within a closed-loop control operation, and the process returns to step S103.

However, when the variation amount exceeds a certain value although it is not an abnormal value, the flow volume cannot be adjusted simply by controlling the infusion solution pump 13. A variation of this extent is considered to be caused not only by a problem in the infusion solution pump 13, but also by the impact of gravity, which arises when the height of the position of the medicinal solution bottle 10 changes more than expected.

In an embodiment of the present invention, when the measured flow volume does not become the set volume by controlling the infusion solution pump 13 (NO in step S109), the flow of the infusion solution caused by gravity is adjusted as follows.

The CPU 40 temporarily stops the infusion solution pump 13 (step S110).

At this point, the flow volume sensor 14 is still operating. Therefore, the CPU 40 can obtain, from signals from the flow volume sensor 14, the flow volume of the infusion solution caused only by gravity, i.e., the flow volume that is unaffected by the operation of the infusion solution pump 13.

Next, the CPU 40 causes the infusion solution pump 13 to resume operation, and causes the constricting unit 15 to reduce the flow volume of the infusion solution caused by the impact of gravity applied on the medicinal solution flowing through the tube 23. For example, when the measured flow volume is higher than the set flow volume, the constricting unit 15 constricts the tube 23 so that the measured flow volume is within a predetermined range with respect to the set flow volume while the infusion solution pump 13 is driven (step S111). This predetermined range is narrower than a range that can be controlled by the infusion solution pump 13.

Subsequently, after continuing the drip infusion for a while and the measured flow volume becomes lower than the set flow volume (YES in step S112), it is considered that the medicinal solution bottle 10 has returned to its original position and the flow of the infusion solution is no longer affected by gravity. Therefore, the CPU 40 uses opening/closing control signals for controlling the constricting unit 15 to release the constriction (step S113). Then, the process returns to step S103 and regular operation is continued.

When the measured flow volume does not become lower than the set flow volume (NO in step S112), the process returns to step S103 and regular operation is continued.

As described above, an embodiment of the present invention includes the constricting unit 15, and therefore the resistance in the flow path of the infusion solution can be changed. Accordingly, it is possible to increase the extent and freedom in the operation of controlling the flow volume performed by the infusion pump system 1.

In a second control operation, the timing of taking a measure to control the flow of the infusion solution caused by gravity is different from that of the first control operation.

The CPU 40 monitors flow volume signals (measured flow volume), and accumulates the flow volumes, and also calculates the increasing rate of the flow volume (step S103′). The flow volume usually varies to some extent, but the usual variation amount is within a predetermined rage.

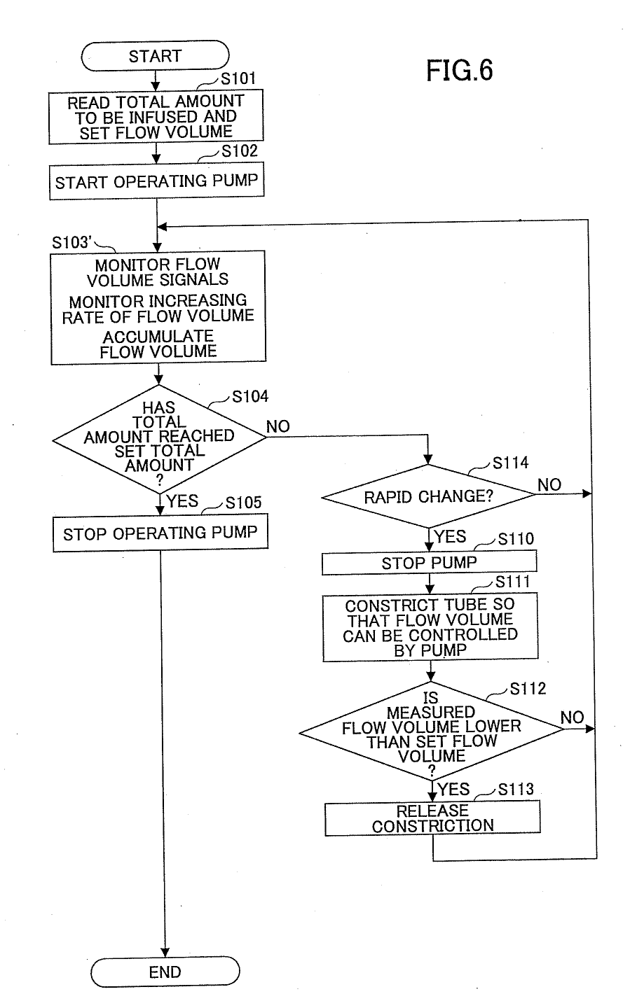

In the present embodiment, the increasing rate of the flow volume is calculated, and when a rapid variation is observed, the infusion solution pump 13 is stopped, and the same measure as that of the first control operation is performed. Specifically, as shown in FIG. 6, when the variation of the measured flow volume within a predetermined period of time exceeds a threshold (YES in step S114), the infusion solution pump 13 is temporarily stopped (step S110). After stopping the infusion solution pump 13, the constricting unit 15 is operated to change the flow path resistance so that the flow volume in the flow path is within a predetermined range with respect to the set flow volume (step S111). By starting the control operation from the time point when the variation of the measured flow volume exceeds a threshold within a predetermined time period, it is possible to reduce the time taken to reduce the actual flow volume to the set flow volume.

Incidentally, as described above, when the system controller SC cannot obtain any signals from the flow volume sensor 14, or when the measured flow volume indicates an abnormally high value that is usually inconceivable, it is highly likely that an external failure has occurred in an element of the infusion pump system 1.

In such a case, the CPU 40 (interruption control unit 61) interrupts the control operations of the first and second control operations. In this case, the infusion solution is stopped even if a program is being executed by any of the elements. The stopping process includes stopping the operation of the infusion solution pump 13 to stop the infusion solution in the infusion solution pump 13 itself, and instructing the constricting unit 15 to block the flow path.

Furthermore, the CPU 40 causes the announce unit 44 to blink or to produce a sound, or uses the wireless communications unit 43 to send a report to a terminal device (external device) that is held by a nurse.

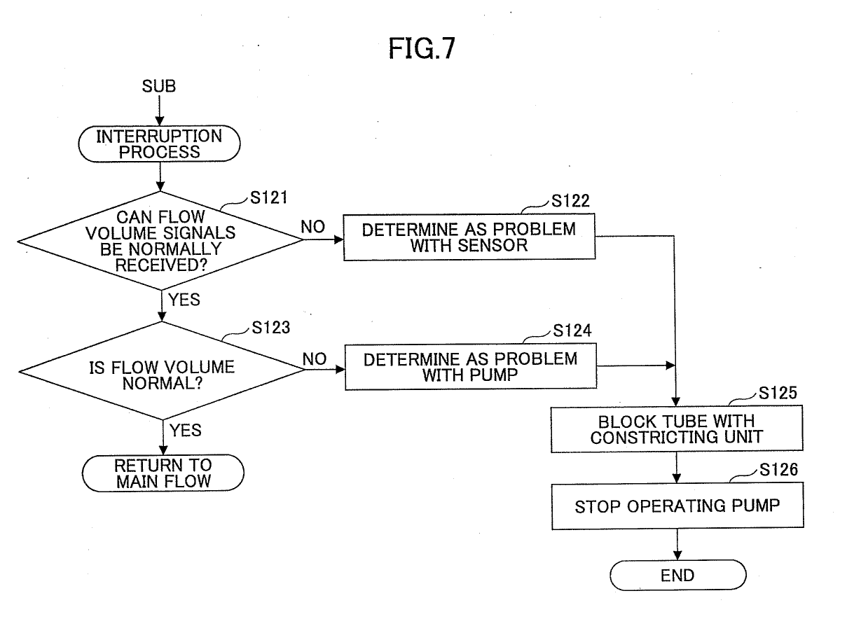

FIG. 7 is a flow chart of a process of performing interruption control when an abnormality occurs.

When the system controller SC can normally receive flow volume signals from the flow volume sensor 14 (YES in step S121), the system controller SC determines that there is no problem with the flow volume sensor 14. Furthermore, when the flow volume is within a normal range (YES in step S123), the system controller SC determines that there is no problem with the infusion solution pump 13. In these cases, the process returns to the main routine as described with reference to FIGS. 5 and 6.

When the system controller SC cannot normally receive flow volume signals from the flow volume sensor 14 (for example, flow volume signals cannot be received at all or the signals indicate a lower voltage than a predetermined voltage) (NO in step S121), the system controller SC determines that there is a problem with the flow volume sensor 14 (step S122). Even when the system controller SC can normally receive the flow volume signals, when the observed flow volume is less than or equal to a threshold (e.g., the flow volume is excessively low or the flow volume is zero, or the flow volume is so high that it cannot be adjusted by controlling the infusion solution pump 13 or by using the constricting unit 15) (NO in step S123), the system controller SC determines that there is a problem with the infusion solution pump 13 (step S124).

Furthermore, there may be an impact on the elements such that the tube is obstructed, the needle falls out, or extravascular administration is performed, or there may be external factors such as the temperature.

In these cases, the interruption control unit 61 causes the constricting unit 15 to block the tube 23 (step S125) and cause the infusion solution pump 13 to stop operating (step S126).

When the system controller SC causes the system controller SC to block the tube 23 in step S125, the system controller SC uses a speaker (not shown) to produce a sound or uses the wireless communications unit 43 to send a report to the nurse.

Furthermore, when the constricting unit 15 blocks the tube 23, the constricting unit 15 sends a report to the system controller SC. Accordingly, the abnormality in the infusion pump system 1 is surely reported to the nurse and the patient.

In the above embodiments, the CPU 40 controls operations of the infusion solution pump 13 and operations of the constricting unit 15; however, these are merely examples. In another example, the CPU 40 may control operations of the infusion solution pump 13 but may not control operations of the constricting unit 15; the flow volume sensor 14 may send the measured flow volume not only to the CPU 40 but also to another CPU, and the other CPU may control operations of the constricting unit 15 in accordance to the received measured flow volume.

Furthermore, in an embodiment of the present invention, the constricting unit 15 detects whether the system controller SC is operating, and when the constricting unit 15 detects that the system controller SC is not operating, the constricting unit 15 autonomously operates and blocks the flow path.

When the system controller SC is operating, the system controller SC inputs, to the constricting unit 15, signals indicating that the system controller SC is operating (hereinafter, “operation signals”). While such signals are being input, the constricting unit 15 does not perform any operations of blocking the flow path.

When the system controller SC stops operating due to some problem (in the worst case because the power source is cut off), it is assumed that all signals output from the system controller SC including the operation signals become LOW. In this case, the constricting unit 15 blocks the flow path in response to detecting LOW signals.

Furthermore, when the system controller SC stops operating due to an emergency, the constricting unit 15 cannot expect to receive power from the system controller SC. Therefore, the constricting unit 15 is preferably equipped with batteries having sufficient capacity for performing at least the operation of blocking the flow path.

Under normal conditions, the constricting unit 15 receives normal signals from the system controller SC, and thus maintains a constant charged state. Under emergencies, the constricting unit 15 preferably performs the blocking operation with the use of the charged power. Accordingly, the constricting unit 15 can block the flow path even when the system controller SC is shut down.

Furthermore, in order to reliably operate the constricting unit 15, the blocked state may be the regular state, and the flow path may be opened when an instruction is received from the system controller SC as the infusion pump system 1 starts operating.

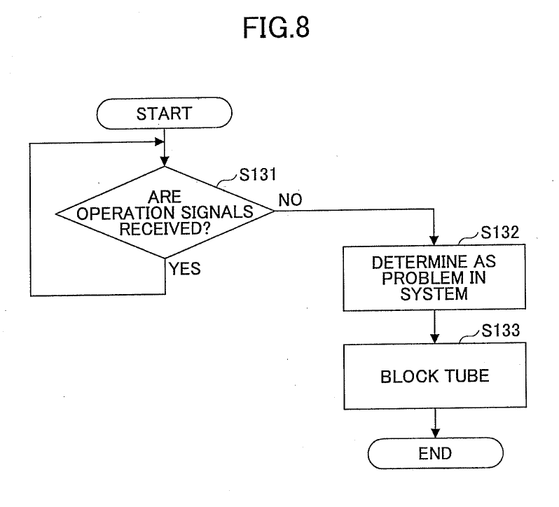

FIG. 8 is a flow chart of an operation performed by the constricting unit 15 when the system controller SC is not operating.

When the constricting unit 15 cannot receive any operation signals (No in step S131), the constricting unit 15 determines that a problem has occurred in the system controller SC (step S132), and blocks the tube 23 (step S133).

Furthermore, when starting the drip infusion operation, before operating the infusion solution pump 13, the system controller SC performs a diagnosis whether the constricting unit 15 can block and open the tube 23. When the constricting unit 15 does not output a signal indicating that the constricting unit 15 has blocked the tube 23, the system controller SC determines that there is an abnormality. Accordingly, the system controller SC causes the announce unit 44 to blink or to produce a sound, or uses the wireless communications unit 43 to send a report to a terminal device (external device) that is held by a nurse. Hence, it is possible to prevent an abnormal drip infusion apparatus from being used beforehand, so that drip infusion can be performed more safely.

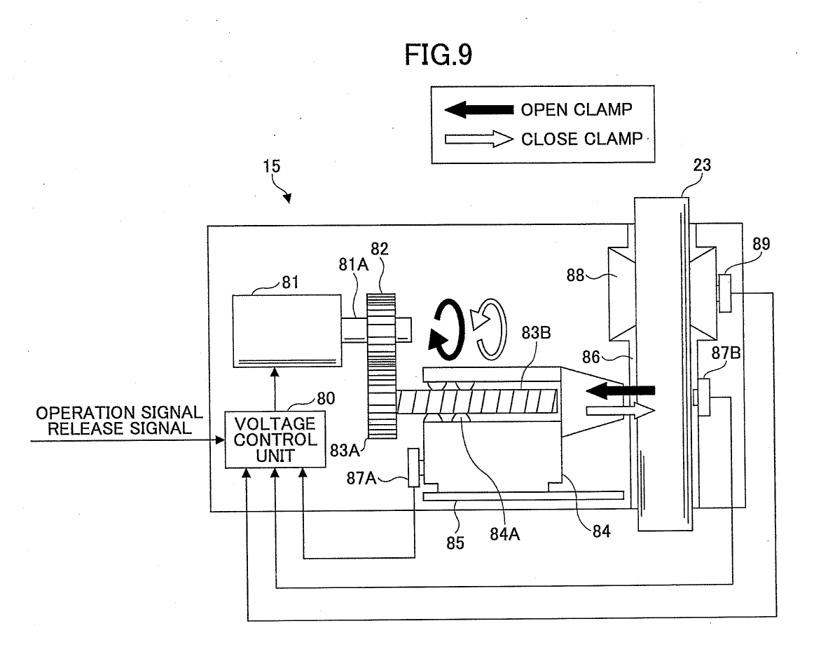

FIG. 9 illustrates a specific example of a flow path resistance changing means for constricting the tube 23.

The constricting unit 15 acting as a flow path resistance changing means includes a stepping motor 81; a first rotational gear 82 attached to a rotational shaft 81A of the stepping motor 81; a second rotational gear 83A that rotates by receiving the rotational force of the first rotational gear 82; a male screw 83B attached to the rotational center shaft of the second rotational gear 83A so as to extend in the opposite direction to the stepping motor 81; and a voltage control unit 80 such as an IC chip for changing the rotation direction of the stepping motor 81 by switching the voltage of the stepping motor 81.

The voltage control unit 80 receives operation signals and release signals from the system controller SC. The constricting unit 15 includes a guide rail 85 having a groove-shaped cross-sectional view. A clamper 84 is attached in such a manner as to freely move along the groove of the guide rail 85.

The clamper 84 has a female screw 84A that is screwed together with the male screw 83B. Accordingly, by driving the stepping motor 81 to rotate the male screw 83B, the male screw 83B changes its position along the axial direction with respect to the female screw 84A of the clamper 84 according to the rotation direction of the male screw 83B. Consequently, the clamper 84 slides by being guided by the guide rail 85.

The constricting unit 15 has a first pressing force sensor 87A for detecting the pressing force from the clamper 84. When the clamper 84 slides toward the stepping motor 81 and presses the first pressing force sensor 87A, the first pressing force sensor 87A detects that it has been pressed by the clamper 84.

The signals output from the first pressing force sensor 87A are transmitted to the voltage control unit 80. As the voltage control unit 80 stops the voltage pulse supplied to the stepping motor 81, the stepping motor 81 stops operating.

Furthermore, the constricting unit 15 includes an insertion hole for inserting the tube 23. On the opposite side of the clamper 84 with respect to the insertion hole, a second pressing force sensor 87B is provided. When the clamper 84 slides and presses the tube 23 inserted in the insertion hole, the diameter of the tube 23 deforms and the tube 23 on the downstream side is constricted, and the tube 23 deforms toward the second pressing force sensor 87B. Accordingly, the second pressing force sensor 87B detects that it has been pressed by the tube 23.

Furthermore, a detector 88 is provided on the outer periphery of the insertion hole in the constricting unit 15. The inner radius of the detector 88 is somewhat smaller than the outer radius of the tube 23. Accordingly, when the tube 23 is inserted into the insertion hole, the tube 23 somewhat pushes out the detector 88, and the tube 23 is gripped by the force of the detector 88 that tries to return to its original shape. Furthermore, on the outer periphery of the detector 88, there is provided a third pressing force sensor 89. The detector 88 that has been somewhat pushed out by the inserted tube 23 detects that the third pressing force sensor 89 has been pressed.

The signals output from the third pressing force sensor 89 are transmitted to the voltage control unit 80. In this case, even if the voltage control unit 80 cannot receive the operation signals from the system controller SC, the voltage control unit 80 starts supplying voltage pulses to the stepping motor 81, and the clamper 84 starts sliding to press the tube 23. Furthermore, when signals are not transmitted from the third pressing force sensor 89 to the voltage control unit 80, it means that the tube 23 is not inserted in the constricting unit 15. In this case, even if the voltage control unit 80 cannot receive the operation signals from the system controller SC, the voltage control unit 80 does not supply voltage pulses to the stepping motor 81. When the voltage control unit 80 receives release signals described above, the voltage control unit 80 supplies voltage pulses to the stepping motor 81 to slide the clamper 84 in a direction in which the constriction to the tube 23 is released.

The present invention is not limited to the specific embodiments described herein, and variations and modifications may be made without departing from the scope of the present invention.

The present application is based on Japanese Priority Patent Application No. 2010-215390, filed on Sep. 27, 2010, the entire contents of which are hereby incorporated herein by reference.

What is claimed is:

1. A solution sending system comprising:
a flow path;
a pump including a space that also serves as part of the flow path;
a flow volume detection unit that detects a flow volume per unit time in the flow path;
a control unit that controls the pump in accordance with a detected value of the flow volume detection unit and a set value; and
a flow path resistance changing unit that changes a flow path resistance in the flow path, wherein
the flow path resistance changing unit changes the flow path resistance in the flow path in accordance with the detected value and the set value.

2. The solution sending system according to claim 1, wherein
the control unit controls the pump such that the detected value becomes the same as the set value, when the detected value and the set value are different.

3. The solution sending system according to claim 1, wherein
the flow path resistance changing unit changes the flow path resistance in the flow path such that the detected value becomes included within a predetermined range with respect to the set value, when the detected value does not become the same as the set value even when the control unit controls the pump.

4. The solution sending system according to claim 1, wherein
the flow path resistance changing unit changes the flow path resistance in the flow path such that the detected value becomes included within a predetermined range with respect to the set value, when an increasing rate of the detected value is greater than or equal to a predetermined value.

5. The solution sending system according to claim 1, wherein
the control unit causes the flow path resistance changing unit to block the flow path when the control unit cannot receive an output signal from the flow volume detection unit or when the detected value exceeds a predetermined threshold.

6. The solution sending system according to claim 1, wherein
the control unit supplies, to the flow path resistance changing unit, an operation signal indicating a normal operation of the control unit while operating, and
the flow path resistance changing unit blocks the flow path when the flow path resistance changing unit cannot receive the operation signal.

7. The solution sending system according to claim 1, wherein
the pump is a diffuser type micro-pump.

8. A solution sending method performed by a solution sending system including
a flow path,
a pump including a space that also serves as part of the flow path,
a flow volume detection unit that detects a flow volume per unit time in the flow path,
a control unit that controls the pump in accordance with a detected value of the flow volume detection unit and a set value, and
a flow path resistance changing unit that changes a flow path resistance in the flow path, the solution sending method comprising:
a step performed by the flow path resistance changing unit, of changing the flow path resistance in the flow path in accordance with the detected value and the set value.

9. The solution sending method according to claim 8, further comprising:
a step performed by the control unit, of controlling the pump such that the detected value becomes the same as the set value, when the detected value is higher then the set value.

10. The solution sending method according to claim 8, further comprising:
a step performed by the flow path resistance changing unit, of changing the flow path resistance in the flow path such that the detected value becomes included within a predetermined range with respect to the set value, when the detected value does not become the same as the set value even when the control unit controls the pump.

11. The solution sending method according to claim 8, further comprising:
a step performed by the flow path resistance changing unit, of changing the flow path resistance in the flow path such that the detected value becomes included within a predetermined range with respect to the set value, when a change rate of the detected value calculated by the control unit is greater than or equal to a predetermined value.
